(19) United States
(12) Patent Application Publication
(10) Pub. No.: US 2011/0138203 A1
(43) Pub. Date: Jun. 9, 2011

(54) UNIVERSAL SERIAL BUS APPARATUS FOR LOWERING POWER CONSUMPTION

(75) Inventors: Chi-Tung Chang, Taipei (TW); Cheng-Kun Chen, Taipei (TW); Chien-Chiang Chiang, Taipei (TW)

(73) Assignee: Alcor Micro Corp., Nangang District (TW)

(21) Appl. No.: 12/754,629

(22) Filed: Apr. 6, 2010

(30) Foreign Application Priority Data
Dec. 9, 2009 (TW) 098141973

(51) Int. Cl. G06F 1/32; G06F 1/06

(52) U.S. Cl. 713/320; 713/501

(57) ABSTRACT

A universal serial bus (USB) apparatus for lowering power consumption is provided. The universal serial bus apparatus includes a universal serial bus circuitry, a monitor unit, and a system duty clock generator. The monitor unit is used to monitor a start of frame (SOF) packet generated by the universal serial bus circuitry and generates a clock control signal accordingly. The system duty clock generator receives the clock control signal and a reference clock signal to generate a system duty clock signal. The enable or disable status of the system duty clock signal can be determined according to the SOF packet monitored by the monitor unit so as to make the universal serial bus apparatus enter into runtime idle mode to lower the power consumption.

### BACKGROUND OF THE INVENTION

1. Technical Field

The present invention relates to universal serial bus (USB) apparatuses for lowering power consumption, and more particularly, to a universal serial bus apparatus for lowering power consumption while the universal serial bus apparatus is idle.

2. Description of Related Art

To move in line with the market, manufacturers aim at developing high-speed, low-price universal serial bus (USB) apparatuses. However, due to an increasing variety of wireless communication products, power conservation has become an important trend in the universal serial bus apparatus industry as well as with its related products.

FIG. 1 is a schematic view of a conventional universal serial bus (USB) apparatus. FIG. 2 is a schematic view of a clock waveform of the conventional universal serial bus apparatus.

Referring to FIG. 1, a conventional universal serial bus apparatus comprises a universal serial bus physical unit 10 (PHY), a universal serial bus transmission interface unit 20, a frame information unit 30, a clock generating unit 40, and at least one application function module 50.

The universal serial bus physical unit 10 receives external data streams. The universal serial bus transmission interface unit 20 sends a start of frame (SOF) packet, which is converted from the external data streams and then relayed to the frame information unit 30. The universal serial bus transmission interface unit 20 arranges a schedule of transmission of the SOF packet according to a clock signal CLK generated by the clock generating unit 40. Hence, the frame information unit 30 sends the SOF packet to the application function module 50 according to the schedule.

Where a universal serial bus apparatus works in conjunction with a memory card-reading system, the application function module 50 includes a memory control unit 50a, a memory card control unit 50b, a central processing unit 50c, etc. The clock signal CLK generated by the clock generating unit 40 is exactly a system duty clock signal CLK_SYS of the application function module 50. Hence, the system duty clock signal CLK_SYS is consistent with the clock signal CLK in terms of signal waveforms, as shown in FIG. 2.

In general, to render a universal serial bus apparatus power-economical and energy-efficient, it can utilize a detection circuit module and a brake to monitor the status of the universal serial bus apparatus. For instance, the detection circuit module detects for an idle current in the universal serial bus apparatus and sends a signal to the brake so as to reduce the operating current. In so doing, the universal serial bus apparatus has several problems. The overall circuitry of the universal serial bus apparatus is disadvantageously complicated. The sensitivity of the detection circuit module affects the energy efficiency and conservation. The detection circuit module is also unavoidably expensive in order to be highly sensitive.

When the detection circuit module and the brake are neither in use nor in operation but the conventional universal serial bus apparatus is operating in a normal mode, the frame information unit 30 still continues to output the SOF packets and prevents a universal serial bus apparatus from entering into runtime idle mode. Thus, the operating current remains unabated, thereby unnecessarily wasting electricity.

### BRIEF SUMMARY OF THE INVENTION

The present invention provides a universal serial bus (USB) apparatus designed to reduce power consumption. The universal serial bus apparatus is equipped with a monitor unit for detecting the idle state of the universal serial bus apparatus in real time and allowing the universal serial bus apparatus to enter runtime idle mode timely so as to reduce power consumption.

The present invention provides a universal serial bus apparatus intended for the reduction of power consumption and equipped with a monitor unit so as to streamline the circuitry structure of the universal serial bus apparatus.

The present invention provides a universal serial bus apparatus for lowering power consumption, wherein the enable or disable status of a system duty clock signal can be determined according to a start of frame (SOF) packet monitored by a monitor unit such that the universal serial bus apparatus automatically enters into runtime idle mode.

To achieve the above and other objectives, the present invention provides a universal serial bus apparatus for lowering power consumption, comprising: a universal serial bus circuitry comprising a universal serial bus physical unit, a universal serial bus transmission interface unit, a frame information unit, a clock generating unit, and at least one application function module; a monitor unit for monitoring a start of frame (SOF) packet outputted from the frame information unit so as to generate a clock control signal; and a system duty clock generator for reading the clock control signal and a clock signal from the clock generating unit to thereby generate a system duty clock signal and send the system duty clock signal to a clock input end of any one of the application function modules.

To achieve the above and other objectives, the present invention further provides a universal serial bus apparatus for lowering power consumption, comprising: a universal serial bus circuitry comprising a universal serial bus physical unit, a universal serial bus transmission interface unit, a frame information unit, a clock generating unit, a memory card control unit, a memory control unit, and a central processing unit (CPU); a monitor unit for monitoring a start of frame (SOF) packet outputted from the frame information unit so as to generate a clock control signal; and a system duty clock generator for reading the clock control signal and a clock signal from the clock generating unit to thereby generate a system duty clock signal and send the system duty clock signal to a clock input end of the memory card control unit, the memory control unit, and the central processing unit.

To achieve the above and other objectives, the present invention further provides a universal serial bus apparatus for lowering power consumption, comprising: a universal serial bus circuitry comprising a universal serial bus physical unit, a universal serial bus transmission interface unit, a frame information unit, a clock generating unit, a hub control unit, a central processing unit (CPU), and a memory control unit; a monitor unit for monitoring a start of frame (SOF) packet outputted from the frame information unit so as to generate a clock control signal; and a system duty clock generator for reading the clock control signal and a clock signal from the clock generating unit to thereby generate a system duty clock signal and send the system duty clock signal to a clock input end of the hub control unit, the central processing unit, and the memory control unit.

Implementation of the present invention at least involves the following inventive steps:

1. Actuation of the monitor unit and the system duty clock generator timely reduces the operating current of the universal serial bus apparatus while in an idle state, so as to lower power consumption.

2. The universal serial bus apparatus equipped with the monitor unit and the system duty clock generator has a relatively simple circuitry structure that dispenses with an intricate detection circuit and brake and is effective in lowering power consumption.

### BRIEF DESCRIPTION OF THE SEVERAL VIEWS OF THE DRAWINGS

A detailed description of further features and advantages of the present invention is given below so that a person skilled in the art can understand and implement the technical contents of the present invention and readily comprehend the objectives and advantages thereof by reviewing the disclosure of the present specification and the appended claims in conjunction with the accompanying drawings, in which:

FIG. 1 is a schematic view of a conventional universal serial bus (USB) apparatus;

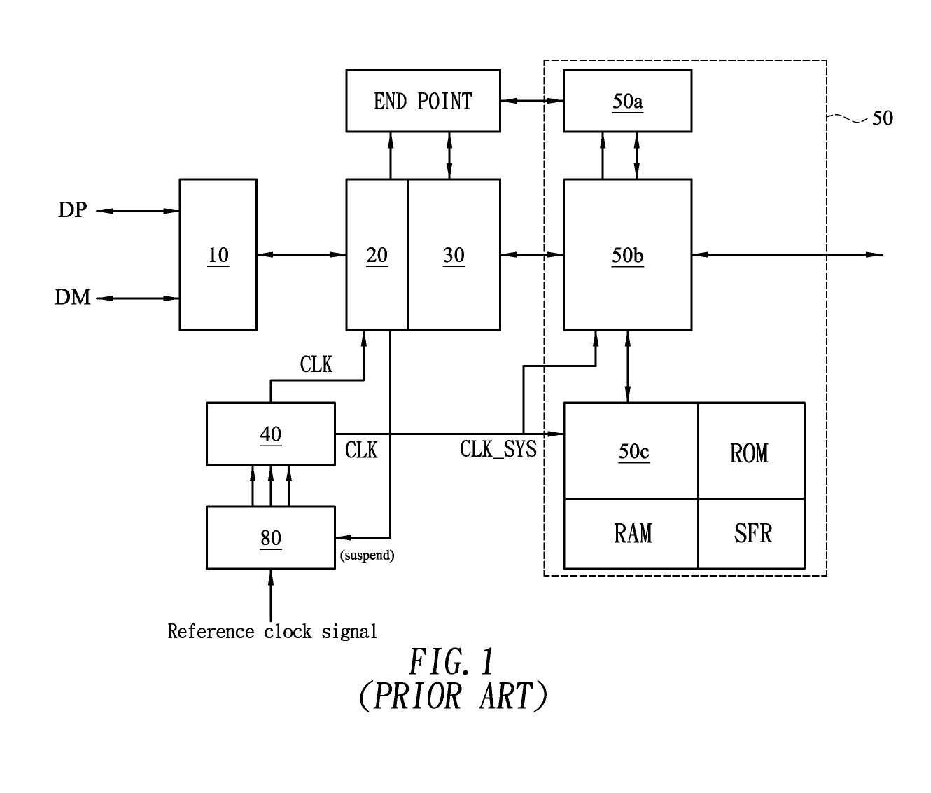

FIG. 2 is a schematic view of a clock waveform of the conventional universal serial bus apparatus;

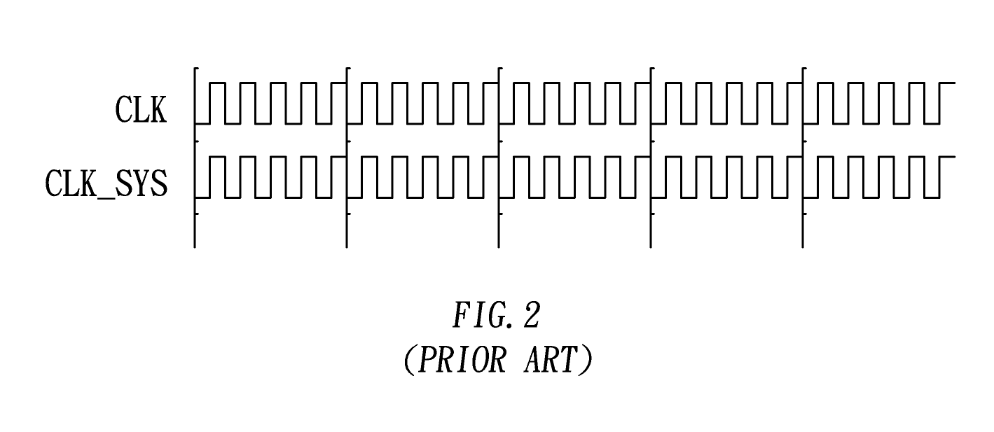

FIG. 3A is a schematic view of a universal serial bus apparatus for lowering power consumption in a first embodiment according to the present invention;

FIG. 3B is a schematic view of the universal serial bus apparatus for lowering power consumption in a second embodiment according to the present invention;

FIG. 4 is a schematic view of a monitor unit and an application function module according to the present invention;

FIG. 5 is a schematic view of clock waveforms of the universal serial bus apparatus for lowering power consumption according to the present invention; and

FIG. 6 is a flow chart of logical implementation of the universal serial bus apparatus for lowering power consumption according to the present invention.

### DETAILED DESCRIPTION OF THE INVENTION

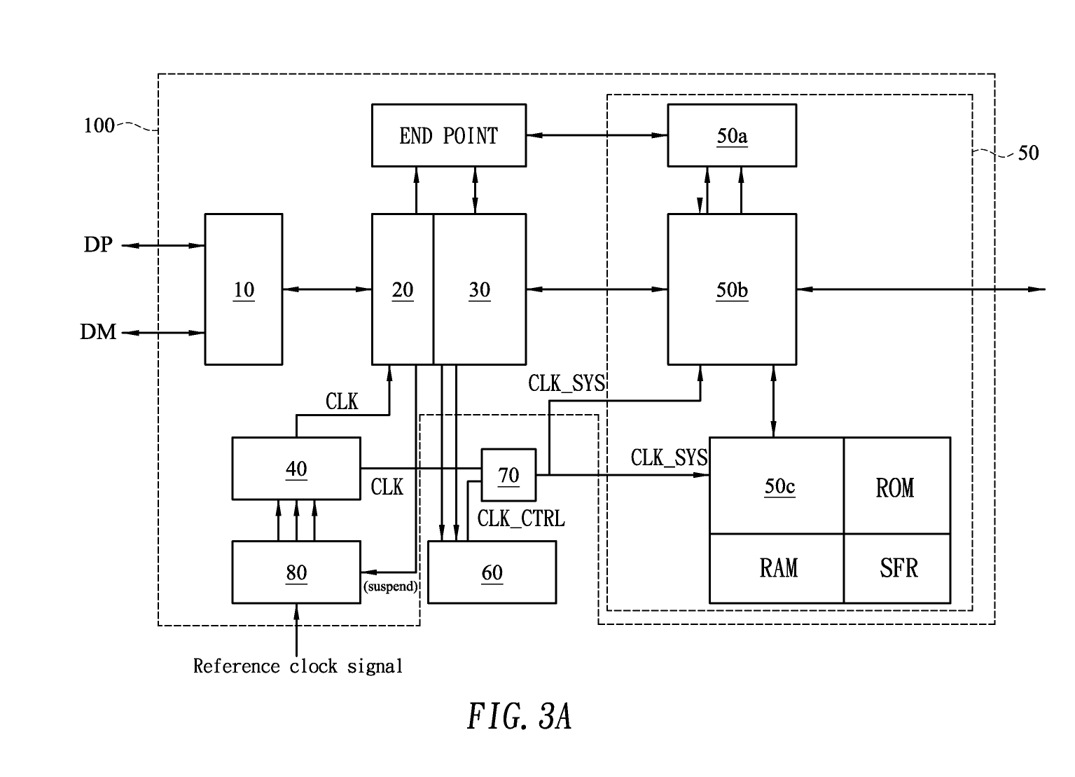

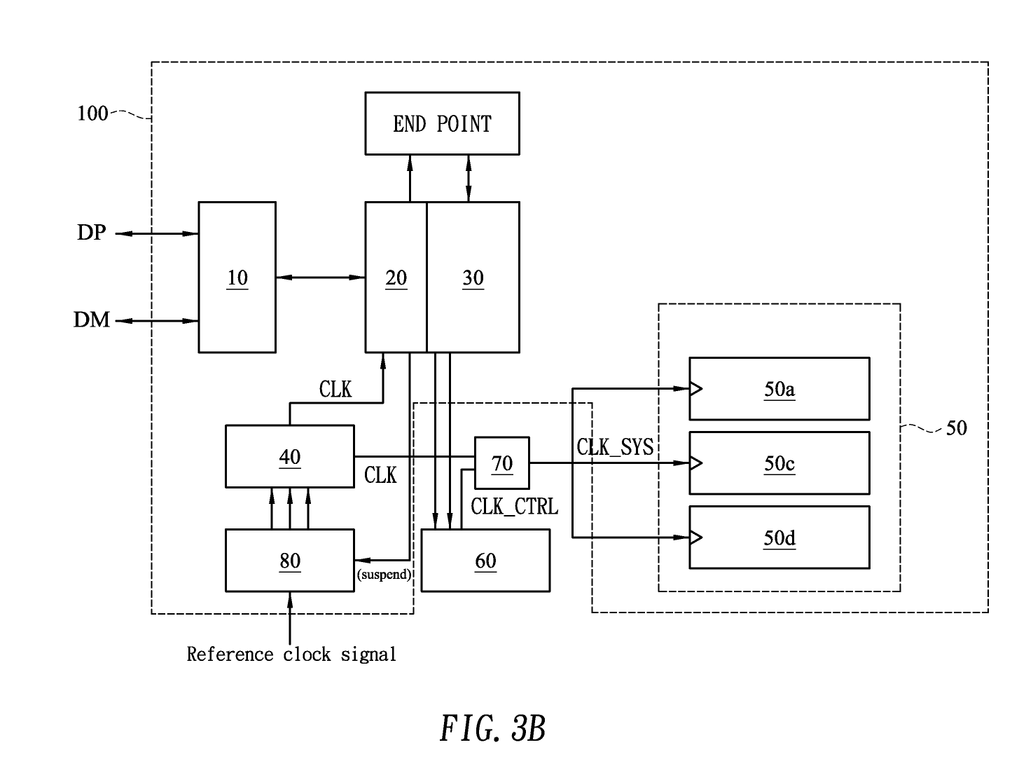

Referring to FIG. 3A and FIG. 3B, in this embodiment, a universal serial bus (USB) apparatus for lowering power consumption includes a universal serial bus circuitry 100, a monitor unit 60, and a system duty clock generator 70.

The universal serial bus circuitry 100 includes a universal serial bus physical unit 10, a universal serial bus transmission interface unit 20, a frame information unit 30, a clock generating unit 40, and at least one application function module 50. The universal serial bus physical unit 10 receives an external data stream. The universal serial bus transmission interface unit 20 converts the external data stream into a start of frame (SOF) packet. The frame information unit 30 outputs the SOF packet and a start of frame (SOF) reset packet.

A reference clock signal configured for use as a reference standard is inputted to a phase locked loop (PLL) 80. Since the phase locked loop 80 is in electrical connection with the clock generating unit 40, it can thereby accurately control clock or frequency. The clock generating unit 40 then can generate a clock signal CLK to be outputted stably. The clock signal CLK thus generated by the clock generating unit 40 is inputted to the universal serial bus transmission interface unit 20 and the frame information unit 30. The frame information unit 30 sends out the SOF packet by following a prearranged command issued by the clock signal CLK.

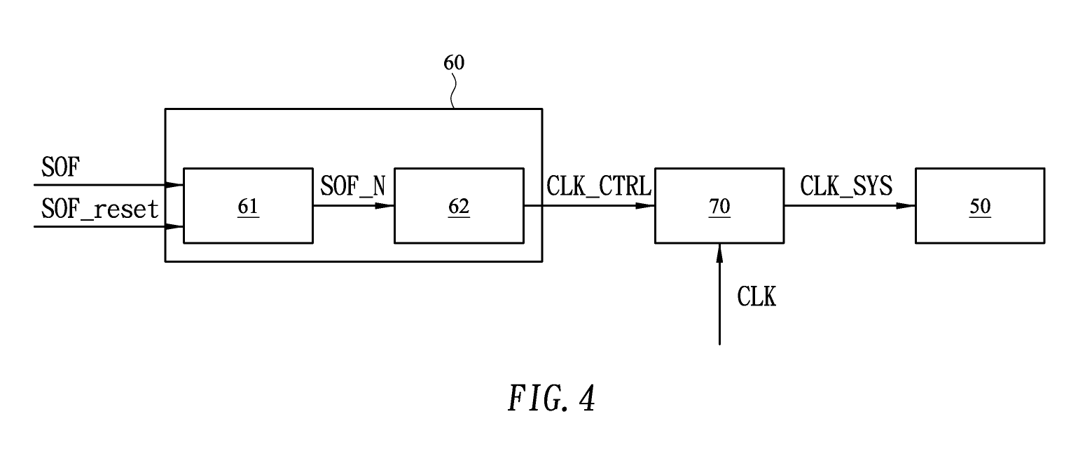

Referring to FIG. 4, the monitor unit 60 monitors the SOF packet outputted from the frame information unit 30 and a start of frame (SOF) reset packet (SOF_reset), and the monitor unit 60 generates a clock control signal CLK_CTRL according to the SOF packet. The monitor unit 60 has at least one start of frame (SOF) counter 61 and an idle time comparator 62.

Referring to FIG. 4, the SOF counter 61 adds up the SOF packets received from the frame information unit 30, and outputs the sum of frame number (SOF_N), so as to calculate the duration of an idle time of the universal serial bus apparatus. The idle time comparator 62 has already been preset to a preset idle number. The preset idle number varies with the universal serial bus apparatuses. The idle time comparator 62 receives the sum of frame number (SOF_N) and compares the sum of frame number (SOF_N) received with the preset idle number to thereby determine whether the universal serial bus apparatus has entered an idle state.

Specifically speaking, where the sum of frame number (SOF_N) is greater than the preset idle number, it indicates that the idle time of the universal serial bus apparatus has actually exceeded a preset idle time. In other words, the universal serial bus apparatus entered into idle state and thereby generated the clock control signal CLK_CTRL accordingly.

Referring to FIG. 4, the system duty clock generator 70 reads the clock control signal CLK_CTRL from the monitor unit 60 and the clock signal CLK from the clock generating unit 40 to thereby generate a system duty clock signal CLK_SYS. Then, the system duty clock generator 70 sends the system duty clock signal CLK_SYS to a clock input end of any one of the application function modules 50.

For instance, the system duty clock generator 70 is an AND gate. Hence, if both the clock control signal CLK_CTRL and the clock signal CLK are at a high level, the system duty clock signal CLK_SYS will be at a high level; otherwise the system duty clock signal CLK_SYS will be at a low level. Where the clock control signal CLK_CTRL is at a high level, it indicates that the universal serial bus apparatus is operating in a normal mode and continuously outputs the system duty clock signal CLK_SYS so as for the universal serial bus apparatus to maintain the operating current. Conversely, where the clock control signal CLK_CTRL is at a low level, it indicates that the universal serial bus apparatus has entered runtime idle mode, and thus it is feasible to stop outputting the system duty clock signal CLK_SYS so as to reduce the operating current of the universal serial bus apparatus.

In a first embodiment, as shown in FIG. 3A, where the universal serial bus apparatus works in conjunction with a memory card reading system, the application function module 50 comprises a memory control unit 50a, a memory card control unit 50b, and a central processing unit 50c. The system duty clock signal CLK_SYS is outputted to the clock input end of the memory card control unit 50b, the memory control unit 50a, and the central processing unit 50c in order to control the operating current thereof.

Where the universal serial bus apparatus is operating in runtime idle mode, the system duty clock signal CLK_SYS pauses. In so doing, the operating current of the memory card control unit 50b, the memory control unit 50a, and the central processing unit 50c decreases to thereby reduce power consumption. The memory card control unit 50b can be a SD (Secure Digital) card control unit, a MS (Memory Stick) card control unit, a MSPRO (Memory Stick Pro) card control unit, a CF (Compact Flash) card control unit, an xD (eXtreme Digital) card control unit, a MMC (MultiMedia card) card control unit, a Smart card control unit, a SM (Smart Media) card control unit, or a combination thereof.

In a second embodiment, as shown in FIG. 3B, where the universal serial bus apparatus works in conjunction with a hub system, the application function module 50 comprises a hub control unit 50d, the central processing unit 50c, and the memory control unit 50a. The system duty clock signal CLK_SYS is sent to the clock input end of the hub control unit 50d, the central processing unit 50c, and the memory control unit 50a in order to control the operating current thereof.

Likewise, where the universal serial bus apparatus is operating in runtime idle mode, the system duty clock signal CLK_SYS pauses. In so doing, the operating current of the hub control unit 50d, the central processing unit 50c, and the memory control unit 50a decreases to thereby reduce power consumption.

Control of the system duty clock signal CLK_SYS is illustrated with correlation in clock waveforms between signals as follows.

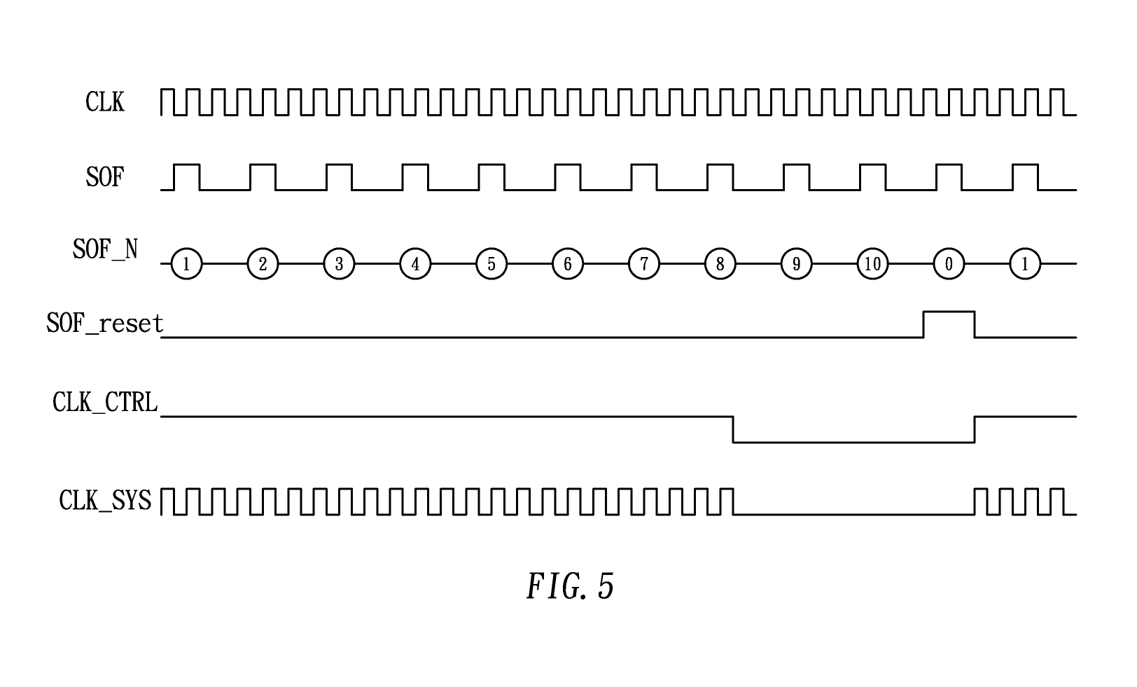

Referring to FIG. 5, the clock signal CLK generated by the clock generating unit 40 and outputted stably is treated as a reference standard. The frame information unit 30 always outputs the SOF packets continuously regardless of whether the external data stream is transmitted or not. Hence, the SOF counter 61 adds up the SOF packets and outputs the sum of frame number (SOF_N) in order to determine whether the external data stream has been transmitted to the universal serial bus apparatus and whether the universal serial bus apparatus can enter into runtime idle mode. The sum of frame number (SOF_N) is the total of the SOF packets.

Where the sum of frame number (SOF_N) is greater than the preset idle number, it indicates that the external data stream has not been transmitted to the universal serial bus apparatus. Thus, the clock control signal CLK_CTRL can be zeroed before it is outputted to thereby stop the system duty clock signal CLK_SYS from being outputted. As a consequence, the operating current decreases, thereby reducing power consumption.

Once transmission of the external data stream begins, the frame information unit 30 will output the SOF reset packet (SOF_reset) to the SOF counter 61 so as for the sum of frame number (SOF_N) to be zeroed and the clock control signal CLK_CTRL to be restored. As a result, the system duty clock signal CLK_SYS will also be restored, which thereby allows the universal serial bus apparatus to exit runtime idle mode and enter into normal mode.

Assuming that the period of each of the clock signals CLK is 125 microseconds, there is an idle time of 625 microseconds whenever the sum of frame number (SOF_N) is 5. If the idle time (Tb) is preset to 875 microseconds, not only does it mean that the sum of frame number (SOF_N) will equal 8 as soon as the SOF counter 61 finds eight said SOF packets, but it also means that the idle time is longer than 875 microseconds. Thus it is feasible to set the preset idle number to 7.

In other words, once the sum of frame number (SOF_N) is larger than the preset idle number 7, the clock control signal CLK_CTRL will output a zeroed signal so as to stop the system duty clock signal CLK_SYS and switch the universal serial bus apparatus to runtime idle mode, thereby reducing the operating current. Hence, by monitoring the SOF packets in real time, it then becomes feasible to switch the universal serial bus apparatus to runtime idle mode.

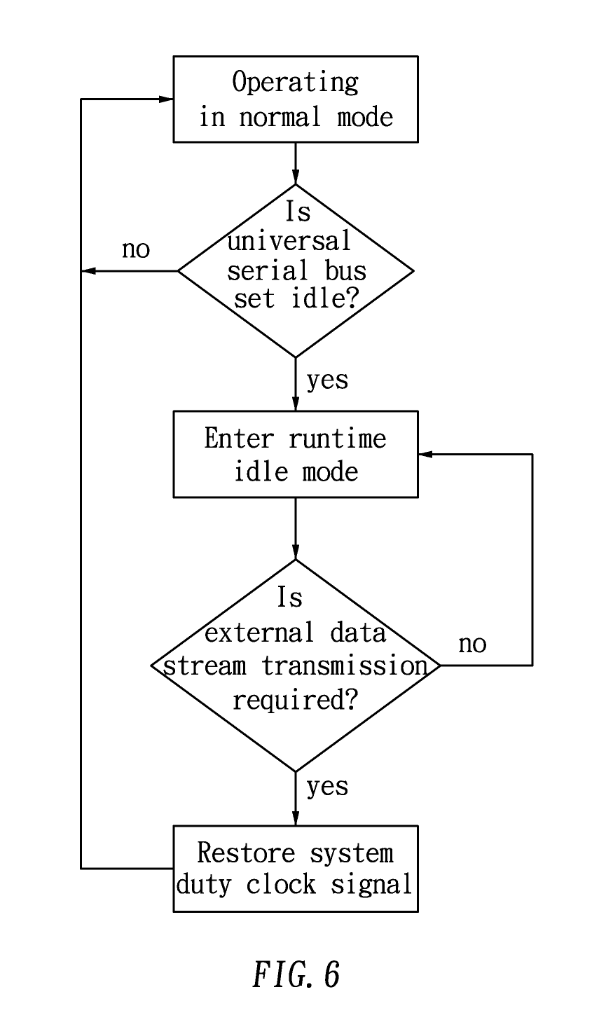

FIG. 6 provides a flow chart of the implementation of the universal serial bus apparatus for lowering power consumption according to the embodiments of the present invention. As shown in the drawing, the monitor unit 60 continuously examines whether the universal serial bus apparatus is idle whenever the universal serial bus apparatus is operating in the normal mode (outputting the system duty clock signal CLK_SYS continually). Upon determination that the universal serial bus apparatus is idle, the universal serial bus apparatus enters into runtime idle mode (stops the system duty clock signal CLK_SYS) and decreases the operating current to thereby reduce power consumption. Upon request for transmission of an external data stream, the outputting of the system duty clock signal CLK_SYS resumes, so as for the universal serial bus apparatus to operate in the normal mode.

In the foregoing embodiments, the universal serial bus apparatus features a reduction in power consumption and a simple framework. Furthermore, the universal serial bus apparatus is equipped with the monitor unit 60 and the system duty clock generator 70 for controlling the system duty clock signal CLK_SYS to thereby reduce the operating current and conserve energy and power.

The foregoing embodiments are provided to illustrate and disclose the technical features of the present invention so as to enable persons skilled in the art to understand the disclosure of the present invention and implement the present invention accordingly, and are not intended to be restrictive of the scope of the present invention. Hence, all equivalent modifications and variations made to the foregoing embodiments without departing from the spirit and principles in the disclosure of the present invention should fall within the scope of the invention as set forth in the appended claims.

What is claimed is:

1. A universal serial bus (USB) apparatus for lowering power consumption, the universal serial bus apparatus comprising:
a universal serial bus circuitry comprising a universal serial bus physical unit, a universal serial bus transmission interface unit, a frame information unit, a clock generating unit, and at least one application function module;
a monitor unit for monitoring a start of frame (SOF) packet outputted from the frame information unit so as to generate a clock control signal; and
a system duty clock generator for reading the clock control signal and a clock signal from the clock generating unit to thereby generate a system duty clock signal and send the system duty clock signal to a clock input end of any one of the application function modules.

2. The universal serial bus apparatus of claim 1, wherein the application function module comprises a memory card control unit, a memory control unit, and a central processing unit (CPU), and the system duty clock signal is sent to the clock input end of the memory card control unit, the memory control unit, and the central processing unit.

3. The universal serial bus apparatus of claim 2, wherein the memory card control unit is a SD card control unit, a MS card control unit, a MSPRO card control unit, a CF card control unit, an xD card control unit, a MMC card control unit, a Smart card control unit, a SM card control unit, or a combination thereof.

4. The universal serial bus apparatus of claim 1, wherein the application function module comprises a hub control unit, a central processing unit (CPU), and a memory control unit, and the system duty clock signal is sent to the clock input end of the hub control unit, the central processing unit, and the memory control unit.

5. The universal serial bus apparatus of claim 1, wherein the monitor unit comprises: a start of frame (SOF) counter for receiving the SOF packets, adding the SOF packets received, and outputting a sum of frame number; and an idle time comparator for receiving the sum of frame number and comparing the sum of frame number received with a preset idle number to thereby generate the clock control signal.

6. The universal serial bus apparatus of claim 5, wherein the frame information unit outputs a start of frame reset packet to the SOF counter so as to zero the sum of frame number.

7. A universal serial bus (USB) apparatus for lowering power consumption, the universal serial bus apparatus comprising:
a universal serial bus circuitry comprising a universal serial bus physical unit, a universal serial bus transmission interface unit, a frame information unit, a clock generating unit, a memory card control unit, a memory control unit, and a central processing unit (CPU);
a monitor unit for monitoring a start of frame (SOF) packet outputted from the frame information unit so as to generate a clock control signal; and
a system duty clock generator for reading the clock control signal and a clock signal from the clock generating unit to thereby generate a system duty clock signal and send the system duty clock signal to a clock input end of the memory card control unit, the memory control unit, and the central processing unit.

8. The universal serial bus apparatus of claim 7, wherein the memory card control unit is a SD card control unit, a MS card control unit, a MSPRO card control unit, a CF card control unit, an xD card control unit, a MMC card control unit, a Smart card control unit, a SM card control unit, or a combination thereof.

9. The universal serial bus apparatus of claim 7, wherein the monitor unit comprises: a start of frame (SOF) counter for receiving the SOF packets, adding the SOF packets received, and outputting a sum of frame number; and an idle time comparator for receiving the sum of frame number and comparing the sum of frame number received with a preset idle number so as to generate the clock control signal.

10. The universal serial bus apparatus of claim 9, wherein the frame information unit outputs a start of frame reset packet to the SOF counter so as to zero the sum of frame number.

11. A universal serial bus (USB) apparatus for lowering power consumption, the universal serial bus apparatus comprising:
a universal serial bus circuitry comprising a universal serial bus physical unit, a universal serial bus transmission interface unit, a frame information unit, a clock generating unit, a hub control unit, a central processing unit (CPU), and a memory control unit;
a monitor unit for monitoring a start of frame (SOF) packet outputted from the frame information unit so as to generate a clock control signal; and
a system duty clock generator for reading the clock control signal and a clock signal from the clock generating unit to thereby generate a system duty clock signal and send the system duty clock signal to a clock input end of the hub control unit, the central processing unit, and the memory control unit.

12. The universal serial bus apparatus of claim 11, wherein the monitor unit comprises: a start of frame (SOF) counter for receiving the SOF packets, adding the SOF packets received, and outputting a sum of frame number; and an idle time comparator for receiving the sum of frame number and comparing the sum of frame number received with a preset idle number to thereby generate the clock control signal.

13. The universal serial bus apparatus of claim 12, wherein the frame information unit outputs a start of frame reset packet to the SOF counter so as to zero the sum of frame number.
